(19) United States
(12) Patent Application Publication
(10) Pub. No.: US 2012/0261443 A1
(43) Pub. Date: Oct. 18, 2012

(54) Lariat for Water Bottle

(76) Inventor: Martha B. BROWN, Newbury Park, CA (US)

(21) Appl. No.: 13/087,856

(22) Filed: Apr. 15, 2011

(51) Int. Cl. A45F 3/14; B23P 11/00

(52) U.S. Cl. 224/250; 29/428

(57) ABSTRACT

A product including an adjustable cord for hands-free portability of a water container, such as a personal drinking water bottle. Also, methods of making and using the product are provided.

### BACKGROUND OF THE INVENTION

1. Field of the Invention

The present invention relates to water containers, and more particularly to an adjustable cord for hands-free portability of a water container.

2. Description of the Prior Art

Generally, it is known in the prior art to provide a lanyard or strap and/or device that closes around the neck of a bottle. Examples of prior art in the field of the present invention include the following:

U.S. Pat. Nos. 6,978,918, 6,966,472, 6,626,333, 6,533,148, 6,443,338, 6,131,780, 6,036,066, 6,029,870, 5,954,247, 5,782,390, 5,622,292, 5,4272,59, 4,498,613, 3,977,638, 3,635,430, 3,543,976, 1,490,066, and 0,853,362; U.S. Design Pat, No. D217,828; US Publication Nos. 20080296325, 20080061091, 20050173477, 20050115996, 20050092789, 20040206789, and 20030121944.

### SUMMARY OF THE INVENTION

The present invention relates to an adjustable cord assembly for hands-free portability of a water container.

It is an object of this invention to provide a product including an adjustable cord having unitary and integral cord body further including a main body portion and a water container securement portion that are adjustable with respect to each other for providing hands-free portability of a water container.

It is another object of this invention is to provide a method for making or assembling a product for hands-free portability of a water bottle including the steps of: providing a cord of at least twice the length of the finished product, adjusting the cord ends with respect to each other to form into at least two components, while maintaining unitary and integral formation of the product, and assembling the at least two components of cord by configuring them with respect to each other to form a main body cord portion and a water container securement cord portion, wherein the at least two components are securedly knotted in an adjustably securedly slidable manner and constructed and configured for releasably but securely sliding the water container securement cord portion to fit around the neck of a water container, thereby providing an adjustable product for hands-free portability of a water bottle.

These and other objects and aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a top view diagram of one embodiment of the invention.

FIG. 2 is a perspective view diagram of an embodiment of the invention.

FIG. 3 is a photographic perspective view of a multiplicity of finished products according to the present invention.

### DETAILED DESCRIPTION

While it is known in the prior art in the relevant field of the present invention to provide provide a lanyard or strap and/or device that closes around the neck of a bottle, there remains a need for a simple product formed and constructed and configured from a unitary, integral and single piece of cord for supporting or suspending the water bottle and for releasably but securely attaching to the water bottle.

Thus, the present invention addresses this longstanding and unmet need by providing an adjustable cord assembly for hands-free portability of a water container, wherein the adjustable cord further includes an unitary and integral cord body having a main body portion and a water container securement portion that are constructed and configured from the same material and that are adjustable with respect to each other for providing hands-free portability of a water container.

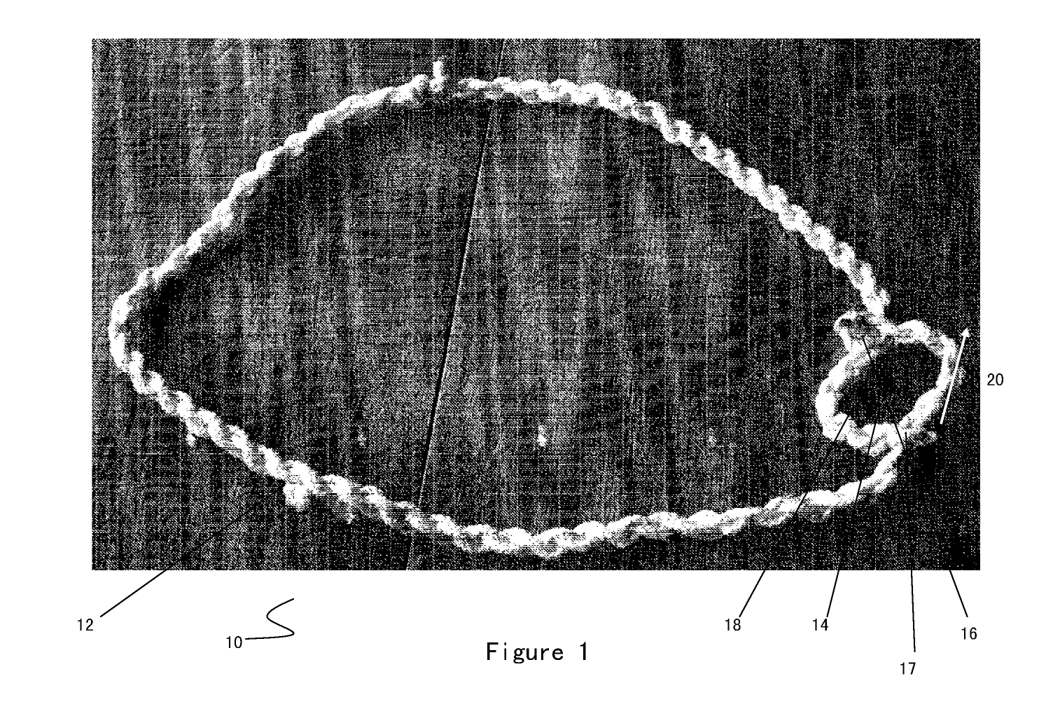

The present invention provides a product including an adjustable cord for hands-free portability of a water container, with illustrations of selected embodiments provided. Referring now to the drawings in general, the illustrations are for the purpose of describing a preferred embodiment of the invention and are not intended to limit the invention thereto. FIG. 1 is a top view diagram of one embodiment of the invention, illustrating the overall unitary and integral single component construction from a single cord piece 10, or an unitary and integral cord body, having a main body portion 12 and a water container securement portion 14 that are constructed and configured from the same material and that are adjustable with respect to each other for providing hands-free portability of a water container. In one embodiment, the adjustability is provided by at least one knot 16; it is optional that more than one knot is provided (16, 17) on opposing sides of the diameter of the water container securement portion of the cord, to form the water containment securement portion that is adjustable between a first open position 18, and a second closed position by slidably adjusting the knot in the direction indicated by indicia 20.

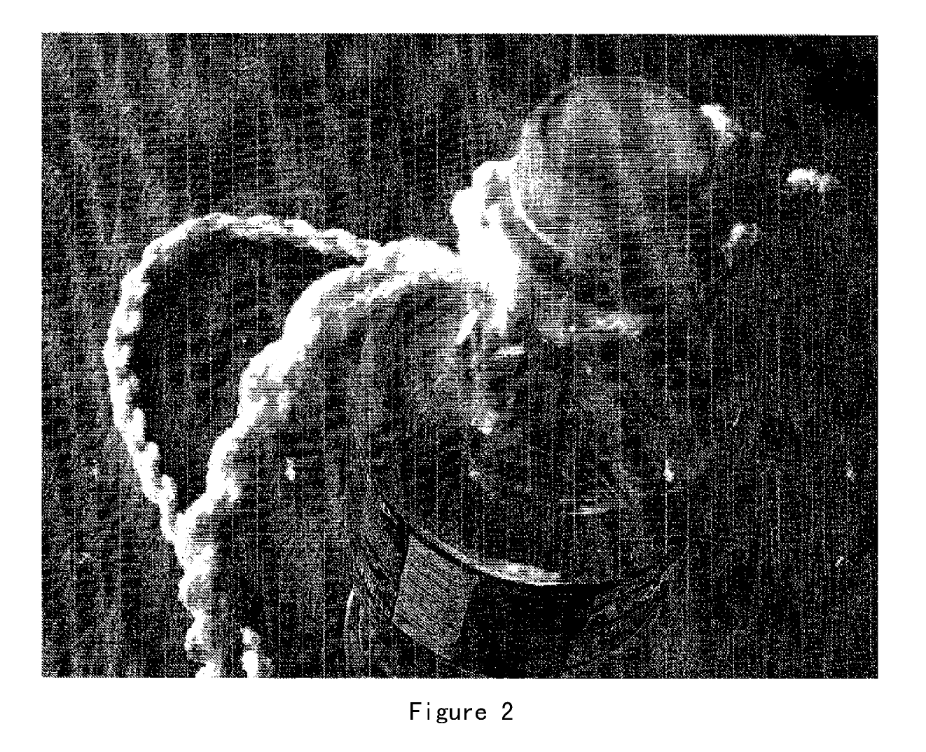

FIG. 2 shows a perspective view diagram of an embodiment of the present invention in a secured or closed position around the neck of a water bottle.

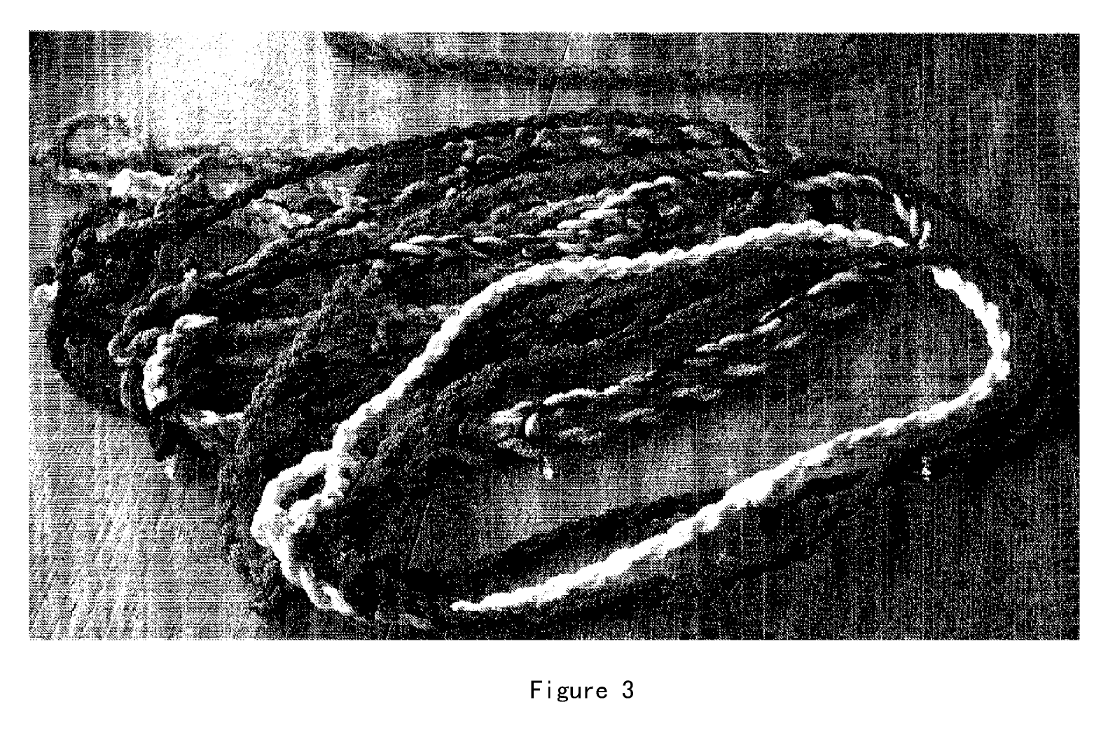

FIG. 3 is a photographic perspective view of a multiplicity of finished products according to the present invention, illustrated colorized cord.

The cord included in the present invention embodiments as illustrated is preferably a solid braid, and more preferably, a nylon solid braid. The solid braid construction provides for stability in the overall product and finished assembly, as well as strength and durability, and grippability for releasably securely attaching the product to a water container, such as by way of example a water bottle having a main body that is substantially cylindrical with a narrow cylindrical neck and opening with a cap or lid that is removable, such as a twist cap 0.5 liter plastic bottle for drinking water. Surprisingly, the solid or single braid nylon is softer than other synthetics and provides for at least some stretch component from the single cord material itself. The cord may be twisted multifilament, and a multiplicity of nylon multifilament twisted strands and/or braided strands may be interconnected to form the unitary, integral and single cord construction of the present invention. Notably, the twisted cord embodiment and/or braided cord embodiment for the material helps to securely hold the loop or opening of the water container securement portion of the cord in place around the water bottle or container when in the closed position; it provides for stability, while also providing for the easy single-handed releasability and single-handed attachability of the product to the bottle neck.

Regarding materials used in the cord included in the present invention, nylon is a preferred material because it is a lustrous fiber that is also strong, soft, and lightweight, with excellent resistance to rot, abrasion, mildew, petroleum products, and most chemicals. In solid braid construction of continuous filaments, an even number of fiber strands all travel the same direction, clockwise or counter-clockwise, and alternate between forming the outside of the cord and the interior of the cord, due to the braided structure and corresponding path of each filament within the solid cord braid.

In embodiments of the present invention, a finished product manufactured according to methods of making the present invention includes an adjustable cord that is between about 5% and about 20%, preferably between about 8% and about 15%, and more preferably about 10% of the length of the original cut cord raw material. By way of example and not limitation, a 18 inches finished product adjustable cord for hands-free portability of a water container would require about 180 inches of cord; and in another example, a finished product measuring 24 inches requires about 240 inches of cord as a raw material (prior to cutting and constructing the embodiment).

By way of example, in one embodiment, 200 inches of cord is doubled over and the ends are tied together to form a knot. The folded end is hooked around a holder and the knotted end is slipped over a second holder, e.g., a stiff cylindrical holder such as approximately the size and shape of a standard pencil. The cord is pulled taut, and then twisted by rotating the second holder, creating uniformly distributed twists per distance, until just before it begins to make kinks, but ensuring that no kinking is allowed. The entire cord is then folded in half again, and from the center out, allowed to twist around itself creating a thicker cord, forming the unitary and integral body cord. The hooked end is carefully slipped from its holder, and the knotted end is passed through that loop. The rope is now capable of being released, as it will not untwist, and provides a balanced and stable twisted cord body. The knotted end, now larger, is passed through the opposite looped end, then tied and preferably knotted around the cord, preferably just behind the loop through which it has just been passed. For embodiments where the cord is made of a synthetic material, this knot and its corresponding knot material can be melted to prevent it from coming untied (alternatively, an adhesive may be provided) so that at least one knot is positioned. The result is two slip loops that tighten when the sides of the cord are pulled. The weight of water in a bottle when inserted into the opening of the water container securement portion, pulls the loops tighter without requiring two-handed adjustment, thereby providing for a product that is single-handedly adjustable for attaching a water bottle thereto. The twist in the cord advantageously holds the loop tight.

In an alternative embodiment according to the present invention, instead of a synthetic cord, natural fibers may be used. In one example, a cotton string formed of twisted staple cotton fibers is provided for the base cord material. In this example, approximately two times as much of the cotton string is required for the same thickness as with the comparable nylon solid braid example in the foregoing, but the cotton embodiment is less expensive from a raw materials and overall manufacturing cost at the time of the present invention. Beneficially, such a natural fiber product is biodegradable; however, it will absorb sweat and dirt, and will shrink if laundered. Notably, it could be disposable afterwards.

In methods of making or assembling and methods of using the product of the present invention, the following steps are provided:

In a method for making or assembling a product for hands-free portability of a water bottle including the steps of:
providing a cord of at least twice the length of the finished product,
adjusting the cord ends with respect to each other to form into at least two components, while maintaining unitary and integral formation of the product, i.e., no distinctly separate components formed of different materials,
assembling the at least two components of cord by configuring them with respect to each other to form a main body cord portion and a water container securement cord portion, wherein the at least two components are securedly knotted in an adjustably securedly slidable manner and constructed and configured for releasably but securedly sliding the water container securement cord portion to fit around the neck of a water container, thereby providing an adjustable product for hands-free portability of a water bottle.

In particular where synthetic materials are used for the cord, the method steps further include the step of finishing the ends of the at least two components of cord to prevent raveling of the cord ends, and more preferably melting or fusing the ends to prevent raveling. For natural fibers, the ends may be finished in alternate ways, such as by way of example and not limitation by applying an adhesive to secure the cord ends from raveling.

In methods of using the product of the present invention, preferably the application of the product to a water bottle is provided by the slidable adjustment of the cord pieces to reduce the size (diameter) of the water container securement cord portion with respect to the other piece of cord that primarily functions as the carrier portion, which is substantially longer than the water containment securement cord portion. Preferably, this adjustment is provided for single-handed adjustment and single-handed attachability by a user. Surprisingly, the braided cord construction and material, in combination with the dimensions and knotted connectivity of the cord, provide for this ergonomic and easy single-handed slidable adjustment.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

What is claimed is:

1. A product for hands-free portability of a water bottle comprising:
a unitary and integral single component construction from a single cord, forming an unitary and integral cord body, having a main body portion and a water container securement portion smaller than the main body portion, wherein the portions are constructed and configured from the same material and are adjustable with respect to each other for providing hands-free portability of a water container.

2. The product of claim 1, wherein the portions are slidably adjustable with at least one knot formed by the cord body.

3. The product of claim 1, wherein the single cord is formed from a solid braided material.

4. The product of claim 1, wherein the single cord is formed from at least one synthetic material.

5. The product of claim 4, wherein the synthetic material is nylon.

6. The product of claim 1, wherein the single cord is formed from natural fibers.

7. The product of claim 1, wherein the single cord is a solid braided cord formed from twisted nylon multifilament.

8. The product of claim 1, wherein the portions are slidably adjustable with a knot formed by the cord body and positioned on opposite sides of the water container securement portion.

9. The product of claim 1, wherein the single cord further includes ends that are processed to prevent raveling.

10. A method for making a product for hands-free portability of a water bottle comprising the steps of:
providing a cord of at least twice the length of the finished product,
cutting the cord into at least two pieces,
assembling the at least two components of cord by configuring them with respect to each other to form a main body cord portion and a water container securement cord portion, wherein the at least two components are securedly knotted in an adjustably securedly slidable manner and constructed and configured for releasably but securedly sliding the water container securement cord portion to fit around the neck of a water container, thereby providing an adjustable product for hands-free portability of a water bottle.

11. The method of claim 1, further including the step of finishing the cut ends of the at least two pieces of cord to prevent raveling of the cord ends.
